(19) United States
(12) Patent Application Publication
(10) Pub. No.: US 2016/0262853 A1
(43) Pub. Date: Sep. 15, 2016

(54) ORAL DENTAL SHIELD AND SYSTEM

(71) Applicant: ARMOR DENTAL, CORP., Hingham, MA (US)

(72) Inventors: Cherie Le Penske, Hingham, MA (US); Lisa M. Fitzgerald, Sarasota, FL (US); Gregg Hallam, San Clemente, CA (US); Katherine A. Haltom, Framingham, MA (US); Gaetano P. LaTorre, Gainesville, FL (US)

(21) Appl. No.: 14/940,668

(22) Filed: Nov. 13, 2015

Related U.S. Application Data
(60) Provisional application No. 62/079,196, filed on Nov. 13, 2014.

(51) Int. Cl. A61C 8/00; A61C 17/02; A61C 13/15

(52) U.S. Cl. CPC A61C 8/008; A61C 19/003; A61C 17/02

(57) ABSTRACT

A temporary, flow-through oral shield system to protect an oral surgical area during a healing process includes a molded body forming a first channel extending from a distal end of the molded body to a proximal end of the molded body and an aperture formed in the molded body in fluid communication with the first channel.

### CROSS-REFERENCE TO RELATED APPLICATIONS

This application claims the benefit of U.S. Provisional Patent Application No. 62/079,196, filed Nov. 13, 2014, which application is fully incorporated herein by reference.

### FIELD OF THE INVENTION

Oral devices and systems are described for use during or after oral surgery and, more specifically, temporary dental oral shields that stabilize gingiva and bone graft and implant surgical areas for several weeks after the surgery.

### BACKGROUND OF THE INVENTION

Most dental bone grafting procedures are done to restore bone as a result of tooth loss, gum disease, or trauma. Bone grafting may also be used to maintain bone structure after tooth extraction. Many bone grafting procedures are also associated with placement of implants. For example, a variety of procedures may be used to build or augment bone so that dental implants may be placed on the resulting bone. Typically, during a dental bone graft, the dentist, periodontist or oral surgeon may conduct a bone grafting procedure in which spare bone from the patient, bones from others, or synthetic bone grafting materials may be placed in the extraction area where bone has been removed or otherwise is missing and close the area with sutures. Often, it may take two or three weeks for the soft tissue in the bone grafting site to heal. Once bone is restored, typically 3 to 6 months after grafting, the dentist, periodontist, or oral surgeon may insert an implant in the patient's mouth. Currently, for dentists, oral surgeons, and periodontists performing implant surgeries, e.g., dental bone grafts, one key to a successful procedure is building up strong bone before the implant is inserted. If the patient does not build up strong bone that heals properly, there can be no successful implant placement.

Disadvantageously, even the most successful and painless mouth surgery can be followed by days or weeks of discomfort for recovering patients. Some implant surgeries require two to three weeks after the bone graft surgery for the surgical area to heal, during which time, the bone graft may be lost or become unstable, which, in a worst case scenario, may require another bone graft. Post-surgery oral hygiene, e.g., tooth brushing, may also cause loss of sutures as well as loss of barrier membranes, e.g., Cytoplast™ membranes (manufactured by Osteogenics Biomedical, Inc. of Lubbock, Tex.), which are often used to hold bone grafting materials in place and to seal the site. Accordingly, one of the biggest challenges for dentists, oral surgeons, and periodontists is stabilizing the surgical area once the bone is packed inside the extraction or augmentation site and the surgical site is sutured up.

Currently, patients may simply walk out after a dental bone graft with a mouthful of sutures, which, by their very nature, may cause patients to continuously explore the surgical extraction site with their tongue, thereby compromising the extraction site and its healing process. Some surgeons may simply provide out-patients with periodontal surgical dressings or packs to cover the extraction site and hope for the best.

A further problem centers on the need for continued oral hygiene in a post-surgical condition. Continued good oral hygiene decreases plaque and bacteria in the mouth, which aids the overall healing process and reduces the potential for inflammation, swelling, and infections. In contrast, infrequent or no oral hygiene increases the likelihood of post-surgery infections. However, even when performing daily oral hygiene properly and carefully, contacting a surgical extraction or augmentation site can be excruciatingly painful, especially if the toothbrush bristles or the toothbrush handle make contact with the surgical area. If oral hygiene becomes painful, the chances the patient will keep up with effective hygiene following mouth surgery are reduced.

### BRIEF SUMMARY OF THE INVENTION

Consequently, there is a need for an oral dental shield that acts as a reliable barrier to protect the site of an implant, extraction, bone graft, and the like for a two- to three-week period after oral surgery. More specifically, there is a need for such an oral barrier device that avoids inadvertent contact with the oral surgical area during oral hygiene activity, e.g., brushing one's teeth, as well as regular, day-to-day activities, e.g., eating.

In a first aspect, a temporary, flow-through oral dental shield to protect an oral surgical area during a healing process is described. In some embodiments, the shield may include a molded body forming a first channel extending from a distal end of the molded body to a proximal end of the molded body and an aperture formed in the molded body in fluid communication with the first channel. In variations of some embodiments, the molded body may include a translucent low durometer elastomer and/or a translucent silicone-based rubber. Other variations may include: a molded body having a detent at the distal end and a detent at the proximal end to abut adjacent teeth. In some implementations, each detent may include a conforming surface having an adhesive layer, e.g., an ultraviolet-curable adhesive, to adhere the conforming surfaces of the shield to the adjacent teeth.

In some variations, the molded body may include a concave undercut portion and a crown portion. In some implementations, the aperture may be disposed in the crown portion of the molded body.

In other variations, the shield may further include a removable spacer. For example, in some implementations, the spacer may be removably disposed in the molded body and may be adapted to provide, when removed, a buffer zone proximate the oral surgical area, to allow a fluid, such as a gas and/or a liquid, to flow across the oral surgical area. Moreover, in some implementations, the removable spacer may include a gripper to facilitate removing the spacer.

In further variations, a second channel may be formed through the molded body to allow a fluid, such as a gas and/or a liquid, to flow across the oral surgical area. For example, the distal end may include a first opening and the proximal end may include a second opening. In some implementations, a seal may be disposed about each of the first opening and the second opening. In some variations, a flow director may be disposed within the first channel proximate the intersection of the first channel and the aperture.

In other embodiments, the molded body may include a compliant resilient material so as to extend from a compressed state to an expanded state. In some variations, the first channel may contain an adhesive liquid and/or an adhesive gel and the molded body may include a first reservoir in fluid communication with a first opening at the distal end and a second reservoir in fluid communication with a second opening at the proximal end. In some implementations, the first and second reservoirs may contain an adhesive liquid and/or an adhesive gel. In some variations, the first and second openings may include at least one flow director. In other variations, the distal end and the proximal end of the molded body may include a conforming attachment surface, e.g., an adhesive surface.

In a second aspect, an oral shield system for providing a temporary, flow-through oral dental shield to protect an oral surgical area during a healing process is disclosed. In some embodiments, the system may include a shield and a disposable packet containing an adhesive, e.g., an ultraviolet-cured adhesive or a non-curable fast setting temporary dental cement. In some variations, the disposable packet may include a nozzle configured to mate with the aperture, to introduce adhesive into the aperture. In other variations, the shield may include a molded body forming a first channel extending from a first opening at a distal end of the molded body to a second opening at a proximal end of the molded body and an aperture formed in the molded body in fluid communication with the first channel. In some implementations, the shield may further include a removable spacer, which is to say that the spacer may be removably disposed in the molded body and adapted to provide, when removed, a buffer zone proximate the oral surgical area to allow a fluid, such as a gas and/or a liquid, to flow across the oral surgical area. Optionally, in some implementations, the system may also include an ultraviolet light source to cure the adhesive.

In a third aspect, a method of providing a temporary, flow-through oral shield to protect an oral surgical area during a healing process is disclosed. In some embodiments, the oral shield may include a molded body forming a channel extending from a first opening at a distal end of the molded body to a second opening at a proximal end of the molded body and an aperture formed in the molded body in fluid communication with the channel. The method may include positioning the oral shield over the oral surgical area, such that the first opening is adjacent to a first tooth adjacent to the oral surgical area and the second opening is adjacent to a second tooth adjacent to the oral surgical area; introducing an adhesive into the aperture until the adhesive contacts the first tooth and the second tooth after flowing through the channel; and curing the adhesive, to adhere the oral shield to the first tooth and to the second tooth. In various implementations, the adhesive may include an ultraviolet-cured adhesive and curing the adhesive may include radiating the ultraviolet-cured adhesive with an ultraviolet light source. Alternatively, the adhesive may be a non-curable fast setting temporary dental cement.

In some variations, the oral dental shield may include a removable spacer and the method may include resting the spacer on the oral surgical area to distance the molded body from the oral surgical area when positioning the oral shield over the oral surgical area, adhering the oral shield in place, and removing the spacer from the molded body of the oral shield to create a buffer zone.

In a fourth aspect, a method of providing a temporary, flow-through oral shield to protect an oral surgical area during a healing process is disclosed. In some embodiments, the oral shield may include a molded body forming a channel extending from a distal end of the molded body to a proximal end of the molded body and containing an adhesive and an aperture formed in the molded body in fluid communication with the channel and the method may include positioning the oral shield in a compressed state over the oral surgical area such that the distal end is proximate a first tooth adjacent to the oral surgical area and the proximal end is proximate a second tooth adjacent to the oral surgical area; expanding the oral shield to an expanded state to provide an interference fit with the first tooth and the second tooth; and curing the adhesive in the channel. In some variations, each of the distal end and the proximal end may include a conforming attachment surface on which an adhesive is applied and the method may further include adhering the conforming attachment surfaces to the first tooth and the second tooth.

In other variations, each of the distal end and the proximal end may include a reservoir containing an adhesive in fluidic communication with a respective opening and the method may further include dispensing the adhesive from the reservoirs through the openings onto the first tooth and the second tooth and curing the adhesive to adhere the oral shield to the first tooth and to the second tooth. In one implementation, the adhesive may include an ultraviolet-cured adhesive and curing the adhesive may include radiating the ultraviolet-cured adhesive using an ultraviolet light source.

In a fifth aspect, a method of providing a temporary, flow-through oral shield to protect an oral surgical area during a healing process is disclosed. In some embodiments, the oral shield may include a molded body with extendable adjustable arms extending across the gap between the first tooth and the second tooth and be adjustable using a tool to the appropriate gap size. In some embodiments, the oral shield may include a molded body forming a channel extending from a distal end of the molded body to a proximal end of the molded body and containing an adhesive and an aperture formed in the molded body in fluid communication with the channel. In other variations each of the distal end and the proximal end may include a conforming attachment surface on which an adhesive is applied and the method may further include adhering the conforming attachment surfaces to the first tooth and the second tooth.

### BRIEF DESCRIPTION OF THE DRAWINGS

The accompanying drawings are not intended to be drawn to scale. In the drawings, each identical or similar component that is illustrated in various figures is represented by a like numeral. For purposes of clarity, not every component may be labeled in every drawing. In the drawings:

FIG. 1 shows a rendering of a buccal cavity with an oral surgical area;

FIG. 2 shows an illustrative embodiment of a flow-through oral shield protecting the oral surgical area of FIG. 1;

FIG. 3 shows a top (plan) view of an illustrative embodiment of an oral dental shield disposed between the teeth adjacent to an oral surgical area in accordance with the present invention;

FIG. 4 shows a side view of the oral dental shield of FIG. 3 in accordance with an embodiment of the present invention;

FIG. 5 shows a cross-sectional view of the oral dental shield taken along line 5-5 of FIG. 3 in accordance with an embodiment of the present invention;

FIG. 6 shows a top (plan) view of an illustrative embodiment of an oral dental shield in accordance with an embodiment of the present invention;

FIGS. 7 and 8 show end and side views of the oral dental shield of FIG. 6 in accordance with the present invention;

FIG. 9 shows a bottom view of the oral dental shield of FIG. 6 in accordance with the present invention;

FIG. 10 shows a top (plan) view of an illustrative embodiment of an oral dental shield with a spacer in accordance with the present invention;

FIG. 11 shows a cross-sectional view of the oral dental shield and spacer taken along line 11-11 of FIG. 10 in accordance with an embodiment of the present invention;

FIG. 12 shows a cross-sectional view of the oral dental shield and spacer taken along line 12-12 of FIG. 10 in accordance with an embodiment of the present invention;

FIG. 13 shows an isometric view of the lingual side of the oral dental shield and removed spacer of FIG. 10 in accordance with an embodiment of the present invention;

FIG. 14 shows an isometric view of the buccal side of the oral dental shield and removed spacer of FIG. 10 in accordance with an embodiment of the present invention;

FIG. 15 shows a side view along the short axis or end view of an illustrative embodiment of a spacer in accordance with the present invention;

FIG. 16 shows a top (plan) view of an illustrative embodiment of a spacer in accordance with the present invention;

FIG. 17 shows a side view along the long axis of an illustrative embodiment of a spacer in accordance with the present invention;

FIG. 18 shows an illustrative embodiment of an assembled kit for an oral dental shield system in accordance with the present invention;

FIG. 19 shows an illustrative embodiment of a disassembled kit for an oral dental shield system in accordance with the present invention;

FIG. 20 shows an end view of an illustrative embodiment of the assembled kit of the oral dental shield system in position in a patient's mouth in accordance with the present invention;

FIG. 21 shows a side view of the assembled kit of FIG. 20 in accordance with an embodiment of the present invention;

FIG. 22 shows a cross-sectional view of the assembled kit along line 22-22 of FIG. 20 in accordance with an embodiment of the present invention;

FIG. 23 shows isometric views of another embodiment of an oral dental shield device in a compressed state and an expanded state in accordance with the present invention;

FIG. 24 shows another isometric view of the oral dental shield of FIG. 23 in an expanded state in accordance with an embodiment of the present invention;

FIG. 25 shows an isometric view of another embodiment of an oral dental shield having adhesive reservoirs in an expanded state in accordance with the present invention;

FIG. 26 shows a cross-sectional view of the oral dental shield of FIG. 25 in accordance with an embodiment of the present invention;

FIG. 27 shows a top (plan) view of another illustrative embodiment of a flow-through oral dental shield with a pair of adjustable arms closed or retracted in accordance with the present invention;

FIG. 28 shows a top (plan) view of the oral dental shield of FIG. 27 with the adjustable arms open or extended in accordance with some embodiments of the present invention;

FIG. 29 shows a cross-sectional view of the oral dental shield of FIG. 27 with the adjustable arms closed in accordance with an embodiment of the present invention; and

FIG. 30 shows a side view of the oral dental shield of FIG. 28 with the extendable arms open in accordance with an embodiment of the present invention.

### DETAILED DESCRIPTION OF THE INVENTION

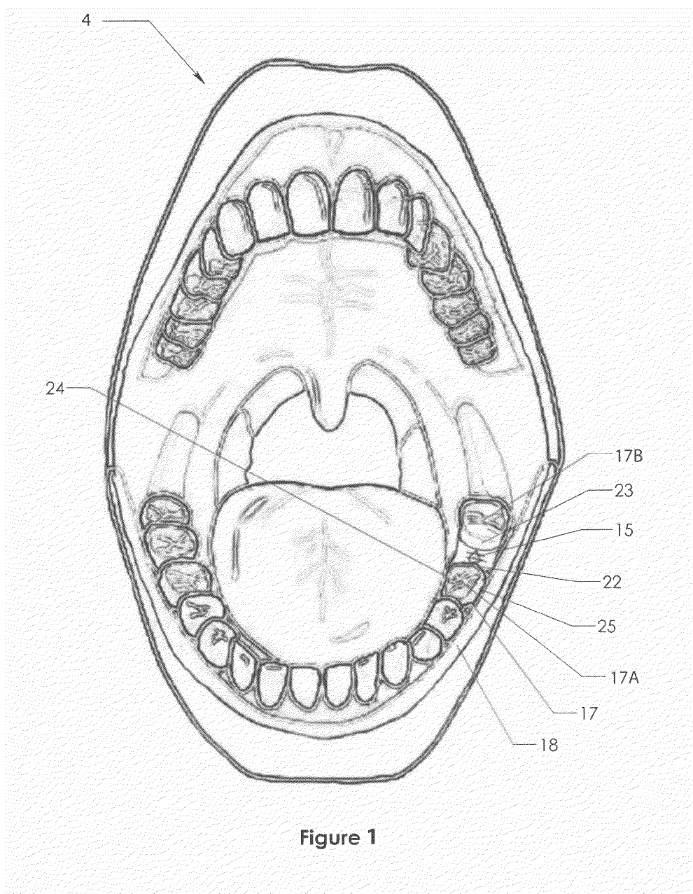

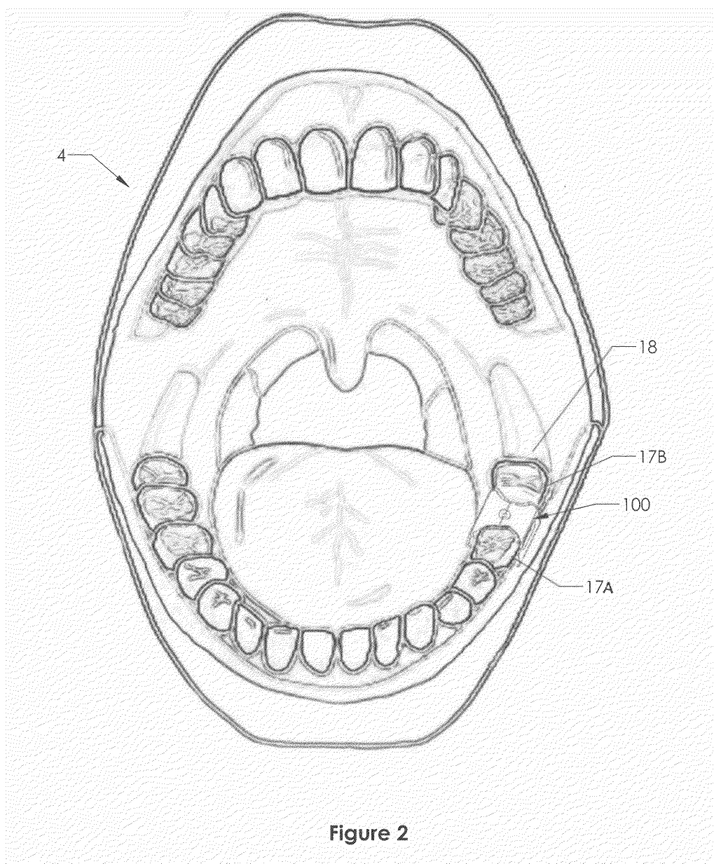

Referring to FIG. 1, an illustrative depiction of a patient's mouth, i.e., buccal cavity 4, is shown. Within the buccal cavity 4, an extraction site 15 is shown amidst a plurality of teeth 17. Typically, at the extraction site 15, the gingiva 18 and surgical sutures are exposed. Immediately adjacent to the extraction site 15 are a first, proximal tooth 17A, whose distal face 22 is exposed to the extraction site 15, and a second, distal tooth 17B, whose mesial face 23 is exposed to the extraction site 15. In a first aspect of the present invention, an illustrative embodiment of an oral dental shield 100 that is adapted to protect the extraction site 15 for up to two to three weeks or even longer is shown in the mouth between teeth 17A, 17B in FIG. 2.

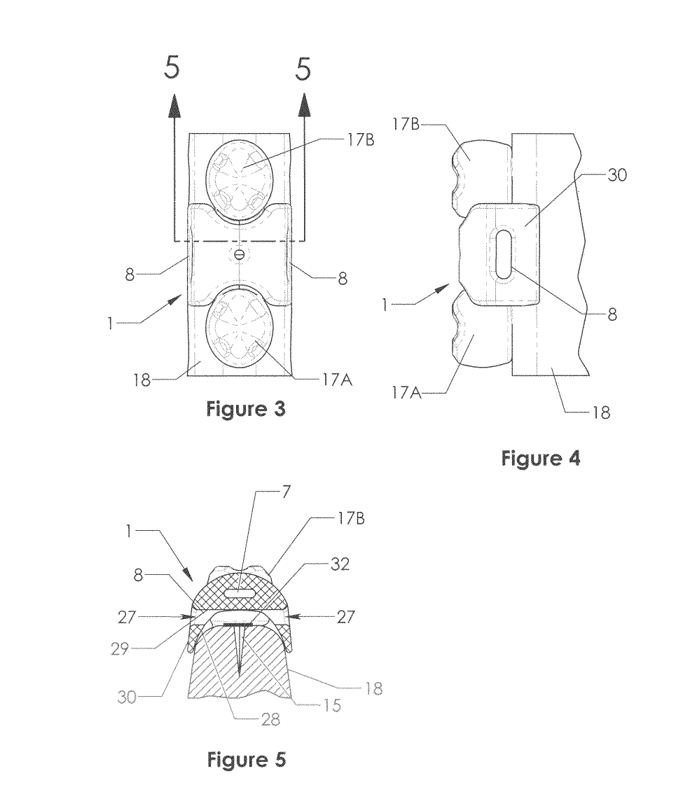

Referring to FIGS. 3, 4, and 5, an oral dental shield 100 that has be installed in a patient's mouth is shown, respectively, in plan view, in side view, and in cross-section. The generally symmetrical shield body 1 is molded, e.g., using a clear and/or translucent low durometer silicone elastomer or silicone rubber material or other suitable material. The clear and/or translucent elastomer or rubber material enables an adhesive, e.g., an ultraviolet-cured adhesive, to be cured fully through the length of shield body 1, e.g., using a standard UV curing light source typically found in dental offices. Alternatively, in one variation, a non-curable fast setting temporary dental cement may be used in lieu of the ultraviolet-cured adhesive. The latter, dental cement does not require a clear and/or translucent molded shield body 1. The shield body 1 may also be formed from a permeable material, e.g., thermoplastic alloy (TPA) and other FDA-approved materials, that allows fluid to pass directly through the shield body 1.

When an ultraviolet-cured adhesive is used, an adhesive channel 7 is formed through the shield body 1. The adhesive channel 7 provides fluid communication between the first, proximal tooth 17A and the second, distal tooth 17B adjacent to the extraction site 15. An adhesive aperture 6 that is in fluid communication with the adhesive channel 7 is formed at a top portion of the shield body 1.

Skirt portions 30 are disposed on the shield body 1, to provide protection to the lingual 24 and buccal sides 25 (FIG. 1) to protect the extraction site 15. In some variations, the inside surface of skirt portions 30 are shaped as a concave, arcuate, and/or rounded surface 28.

Preferably, in use, the shield body 1 is not attached directly atop, resting on or supported by the gingiva 18 at the extraction site 15. Indeed, due to the collection of serosanguinous drainage 32 between the gingiva 18 and the inferior surface 29 of the shield body 1 and, moreover, the need to remove serosanguinous drainage 32 from the extraction site 15 and to flow an hygienic, antiseptic rinse over the extraction site 15, to expedite healing, an air gap, e.g., a flow path 27, above the surface of the extraction site 15 and through the shield body 1 can be formed. Serosanguinous drainage 32 is a thin, watery drainage that is composed of both blood and serum. Such drainage 32 is normal in the early stages of healing, as blood is present in small amounts. Retained fluid can contribute to infection or other complications if left continuously proximate the extraction site 15. Hence, the flow-through type oral shield device 100 includes a rinse path 27 through rinse apertures 8, to protect the extraction site 15 and to remove serosanguinous drainage 32, as further described herein.

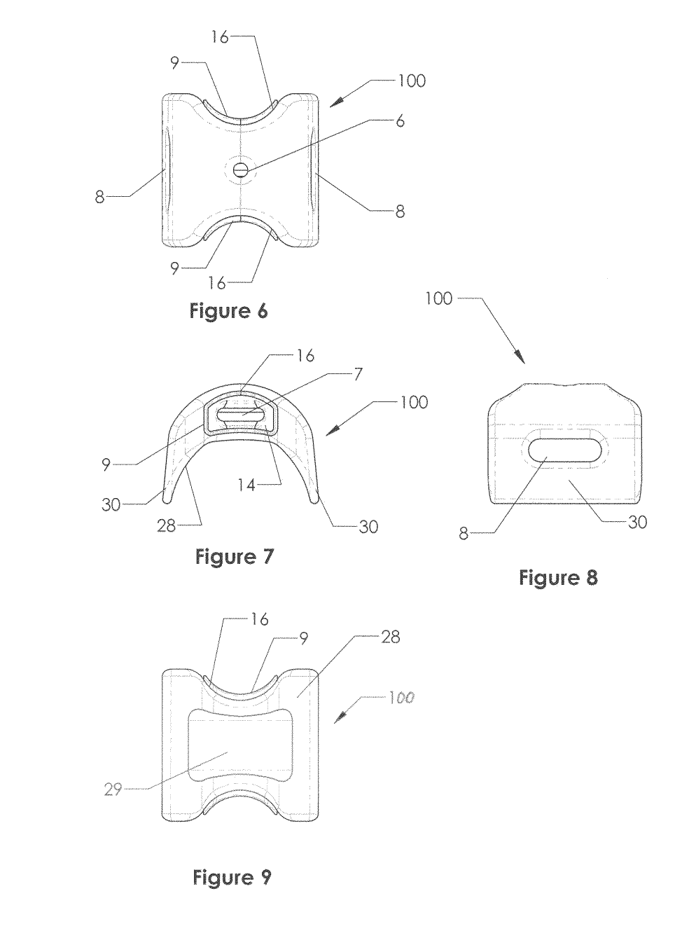

FIGS. 6-9 show an illustrative embodiment of the oral dental shield 100, respectively, in plan view, in end view, in side view along the long axis, and in bottom view. The oral dental shield 100 further includes detent portions 16 that are configured to abut the teeth 17 adjacent to the extraction site 15. Referring to FIGS. 1 and 3, as shown from the perspective of the occlusal of a typical tooth 17, the tooth detent 16 is captured by the distal face 22 of the first, proximate tooth 17A and the mesial face 23 of the second, distal tooth 17B. This locks the shield body 1 in place, preventing the shield body 1 sliding on the gingiva 18 toward the lingual face 24 side (palatal for the maxilla) or the buccal face 25 side of the teeth 17.

Although the figures show an extraction site 15 from which a single tooth has been extracted, this is done for illustrative purposes only, as an extraction site could extend across more than one extracted tooth. Accordingly, the oral dental shield 100 may be sized of any length, to accommodate extraction sites of different sizes, including those that span multiple extracted teeth in children and adults. For example, the average tooth size for an adult male may vary between about 7.07 mm for a lateral incisor of the maxillary arch to about 10.35 mm for a first molar of the maxillary arch and between about 5.68 mm for a central incisor of the mandibular arch and about 11.23 mm for a first molar of the mandibular arch. The average tooth size for an adult female may vary between about 6.76 mm for a second premolar of the maxillary arch to about 10.03 mm for a first molar of the maxillary arch and between about 5.55 mm for a central incisor of the mandibular arch and about 10.81 mm for a first molar of the mandibular arch. The average tooth size for male and female children would be even less at both ends of these ranges.

The detent portions 16 of the shield body 1 may further include an adhesive contact surface 14 that is constrained by a pliable adhesive seal or gasket 9. The adhesive seal or gasket 9 may be an integral part of the shield body 1 or may be a separate seal or gasket 9 that is added to the shield body 1. The pliable nature of the oral dental shield 100 may be obtained by its thin wall section as a molded integral part of the shield body 1. The pliable adhesive seal or gasket 9 is provided to conform to surface variations and curvature of typical tooth 17 surfaces. The pliable adhesive seal or gasket 9 also allows for distance variation between adjacent teeth 17 relative to the extraction site 15, thereby allowing the oral dental shield 100 to be manufactured in length increments of, for example, 0.5 millimeter. As shown in FIGS. 8 and 9, the rinse apertures 8 and rinse channel 27 can be oriented orthogonally or substantially orthogonally to the adhesive channel 7 opening. The seal or gasket 9 can be of any suitable form, such as a flange, lip, wing, etc. and generally circumscribes the channel 7, to provide a reliably large area for the adhesive to cure and attach to an adjacent tooth 17A, 17B.

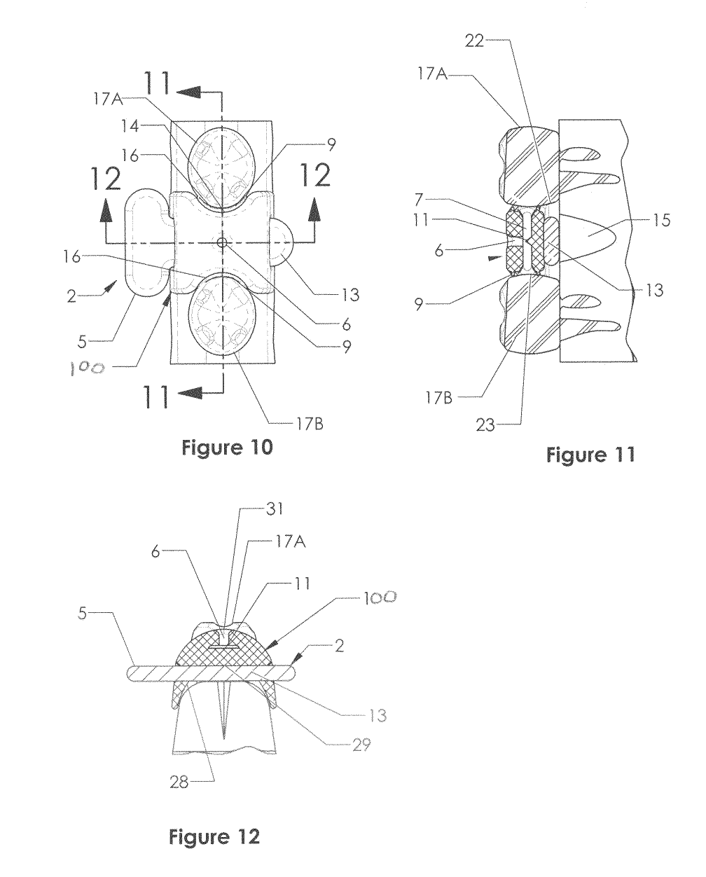

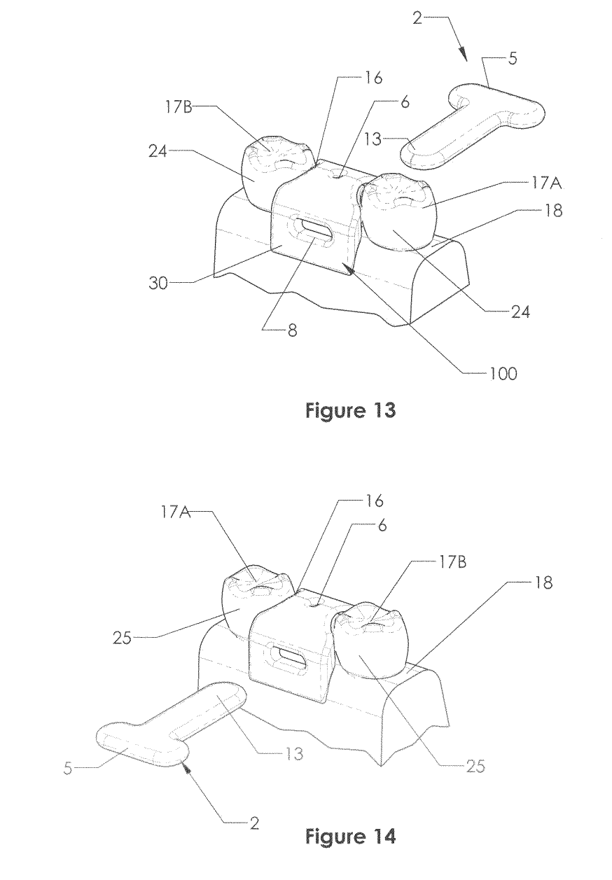

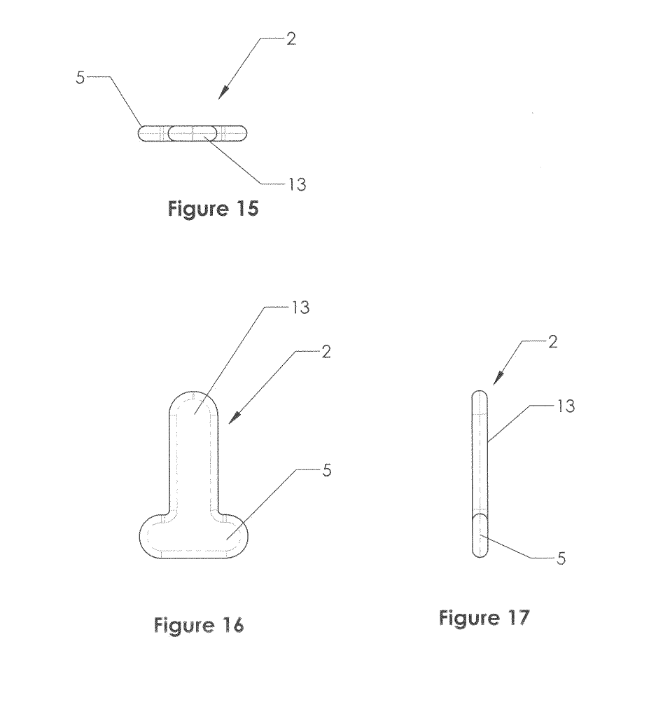

Having described an oral dental shield 100, a second aspect of the present invention will now be described. In some embodiments, the second aspect includes a flow-through shield system. As shown in FIGS. 10-17, the flow-through shield system includes the oral dental shield 100 and a removable spacer 2. The removable spacer 2 may be substantially T-shaped to include a wider spacer grip portion 5, to facilitate manual removal, and a thinner, elongate spacer body portion 13. The removable spacer 2 is configured to constrain the position of the oral dental shield 100 relative to the gingiva 18 during installation by means, e.g., the thickness, of the spacer body 13. More specifically, the removable spacer 2 may be used to position the inferior surface 29 of the oral dental shield 100 at some distance (height), e.g., the thickness of the spacer body 13, above the gingiva 18 at the extraction site 15. Advantageously, the removable spacer 2 is constrained within the rinse aperture 8 of the shield body 1. Hence, once the spacer 2 is removed from the oral dental shield 100, the rinse channel 27 is opened on the buccal and lingual sides of the gingiva 18 and the extraction site 15. The removed spacer 2 provides an air gap and a rinse channel 27 in the oral dental shield 100.

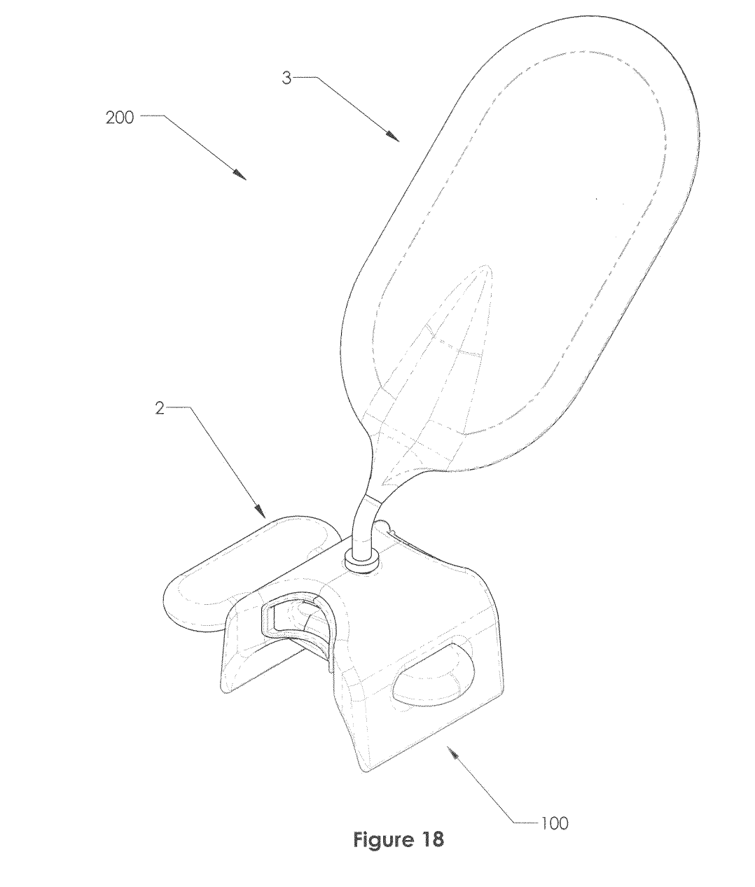

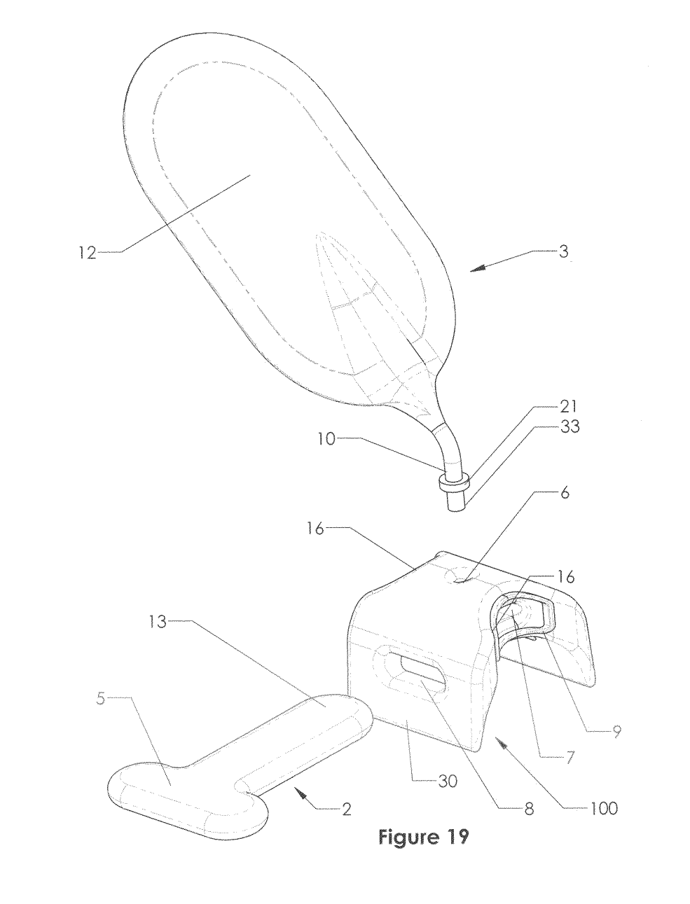

Having described an illustrative oral shield system and an illustrative oral dental shield 100, an illustrative embodiment of an oral shield system kit 200 will now be described. Referring to FIGS. 18-22, in some embodiments, the kit 200 includes the oral dental shield 100 and spacer 2 of the flow-through shield system in combination with an adhesive, e.g., a UV-cured adhesive, packet 3. In some variations, the adhesive packet 3 includes a pair of opposing side walls 12, the edges of which are adhered together. For example, the side walls 12 are constructed from a metal foil to block UV radiation, thereby preventing UV curing of the adhesive while stored, awaiting use. An adhesive tube 10 and a tube stop 21 are disposed at one end of the adhesive packet 3. The tube 10 provides a conduit for delivering an adhesive into the adhesive channel 7 of the oral dental shield 100. More specifically, the adhesive tube 10 includes a nozzle 33 that is dimensioned to have an outer diameter dimensioned to be received in the adhesive aperture 6 formed in the shield body 1. The tube stop 21 helps to provide a seal about the adhesive aperture 6, so that adhesive from the adhesive packet 3 flows through the adhesive channel 7 to both adhesive faces 14 of the oral dental shield 100 rather than escaping out of the adhesive aperture 6.

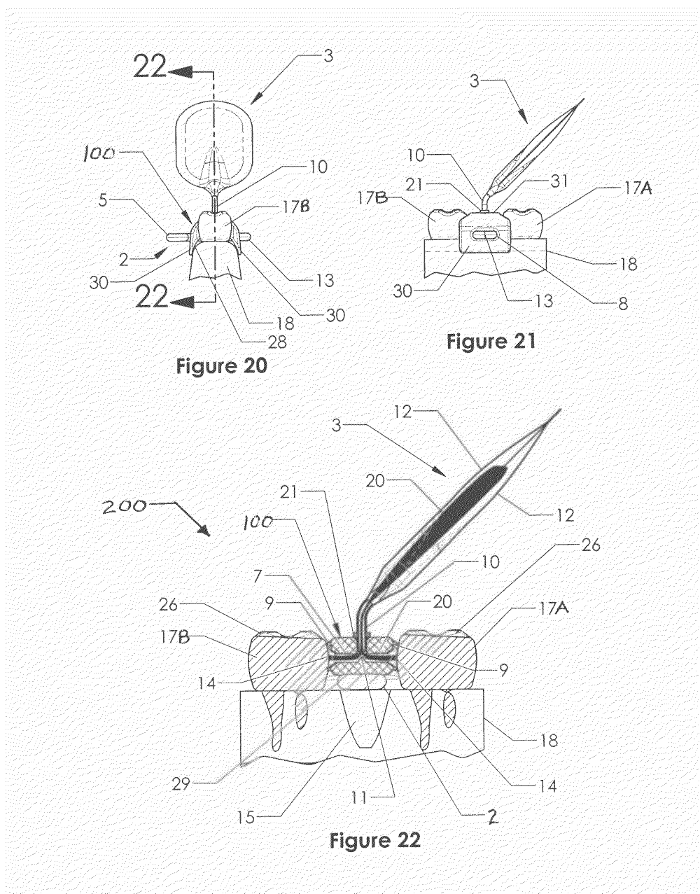

Referring to FIGS. 20-22, a method of using the kit 200, oral shield system, and oral dental shield 100 will now be described. In some embodiments, the oral dental shield 100 is secured to the area above the gingiva 18 at the extraction site 15 by adhering the shield body 1 to the first, proximate tooth 17A and the second, distal tooth 17B, e.g., using a UV-curable adhesive 20. In some variations, the oral shield system is inserted into the buccal cavity 4 above the extraction site 15 manually, e.g., by holding the spacer grip 5. Preferably, the superior face 31 on oral dental shield 100 is positioned on a plane below the occlusal 26 of adjacent teeth 17A, 17B. The spacer 2 may rest on top of the gingiva 18 at the extraction site 15 until the oral dental shield 100 is adhesively attached to the adjacent teeth 17A, 17B.

After the shield body 1 has been placed over the gingiva 18 at the extraction site 15, an adhesive 20 can be applied to adhesively attach the oral dental shield 100 to the adjacent teeth 17A, 17B. Advantageously, the adhesive, e.g., an ultraviolet-cured UV adhesive 20, is contained in the adhesive packet 3. The nozzle 33 of the packet tube 10 can be inserted into the adhesive aperture 6 until the tube stop 21 contacts the shield body 1 or may be supplied already attached. The UV adhesive 20 is then applied to the shield body 1 by means of the packet tube 10. For example, the packet side walls 12 can be pressed together to expel the UV adhesive 20 through the packet tube 10 and into adhesive tunnel 7 located inside shield body 1. The adhesive tunnel 7 directs the UV adhesive 20 to the adhesive contact area 14 on the proximal surface of each adjacent tooth 17A, 17B. Advantageously, a flow director 11 can be included at the junction or place of intersection, e.g., on median sagittal plane of the oral dental shield 100, of the adhesive aperture 6 and the adhesive channel 7. The flow director 11 is configured to direct the UV adhesive flow to both ends of adhesive tunnel 7. Once sufficient UV adhesive 20 is in contact with the distal face 22 of the first, proximal tooth 17A and the mesial face 23 of the second, distal tooth 17B, the adhesive 20 at the interface 14 and within the adhesive channel 7 may be cured, e.g., using an UV light source. Advantageously, the clear, translucent material of the shield body 1 makes curing adhesive 20 within the adhesive channel 7 and at the interfaces 14 possible.

After the UV adhesive 20 is applied and cured, the packet 3 and the spacer 2 may be removed manually, e.g., by means of spacer grip 5. The removed spacer 2 leaves in its place a flow-through rinse channel 27 accessed through rinse apertures 8 that are on the lingual 24 and buccal sides 25 of the teeth 17. The flow-through shield system provides a molded shield body 1, to mechanically protect the extraction site 15 as well as a rinse path 27 for removing serosanguinous drainage 32 from and for introducing an hygienic, antiseptic rinse to the extraction site 15. Indeed, a swirling rinse of the mouth forces liquid down rinse path 27 and across extraction site 15.

Although the method has been described using a UV-cured adhesive, this has been done for illustrative purposes only. There are a myriad of adhesives, especially fast setting, non-curing, temporary dental cements and resins, that may also be adapted for use with the oral shield devices described herein. For example, temporary dental cements and resins, such as those conventionally used in connection with temporary crowns, to maintain oral tissues and protect the restorative site while the permanent crown is manufactured. These cements and resins are easily removed from around the margins at the time of application; provide a good marginal seal to help minimize sensitivity; provide good retention while being easily removed; are compatible with provisional resin restoration, resin core materials, bonding agents, and permanent cements; and exhibit low solubility in oral fluids. A non-exhaustive list of commercially available temporary cements and resins that have a fast setting time, e.g., five to ten minutes; provide good retention for up to three weeks after placement; are easily removed after three weeks without damaging the adjacent teeth or leaving a residual adhesive behind; and are able to adhere to sound tooth enamel, as well as crowns made of gold, porcelain, and/or ceramics; include: zinc oxide eugenol (ZOE), zinc oxide non-eugenol (ZONE), resin temporary cement, calcium hydroxide-based cement, glass ionomer temporization cement (GIC), and polycarboxylate cement.

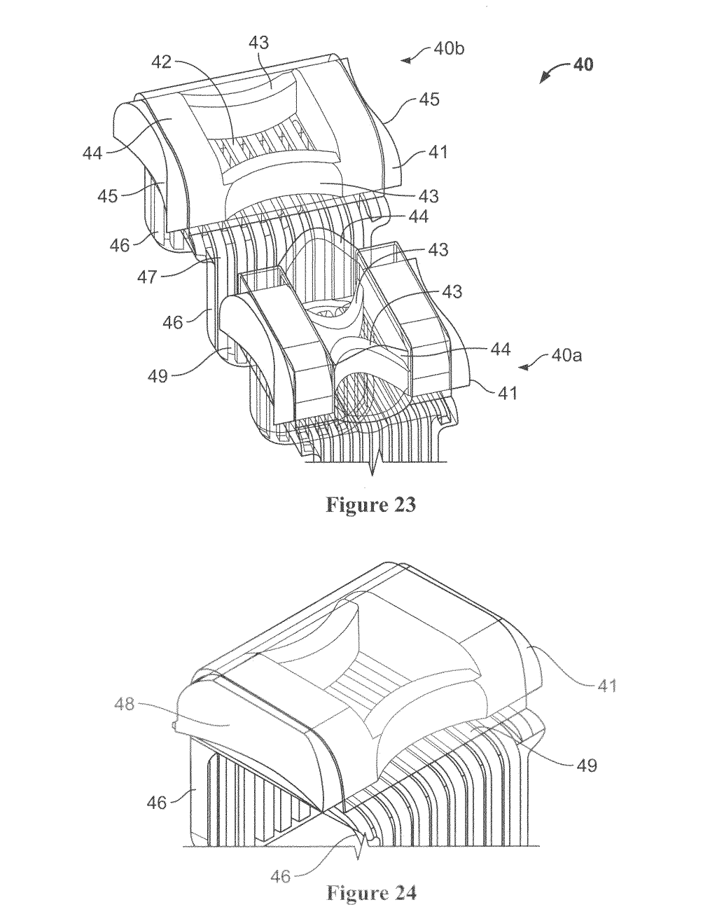

Referring to FIGS. 23 and 24, another illustrative embodiment of an oral dental shield 40 is shown in each of a compressed state 40a and an expanded state 40b. Preferably the oral dental shield 40 is made of a flexible, resilient material that, initially, can be slightly compressed, which is to say, in a compressed state 40a, while retaining sufficient spring force that, due to the material properties, to the design of the oral dental shield, and/or to the geometry of the oral dental shield, e.g., a bow spring, can transition the shield 40 from the compressed state 40a to the expanded state 40b automatically or with some manual manipulation. The amount of compression between the compressed state 40a and the expanded state 40b may be up to about 2 mm to 3 mm and the oral dental shield 40 may be dimensioned for gaps of between 5 mm and 13 mm; although shields 40 to accommodate shorter and wider gaps are also possible.

In some implementations, the oral dental shield 40 may include a body 41, a pair of skirts 46, and an open channel 42. The body 41 may be molded and can include a pair of opposing, expanding side walls 43 and a pair of opposing, anchor side walls 45. The expanding side walls 43 are adapted, e.g., bowed in, to provide an expansive spring force when inserted over an extraction site, between adjacent teeth. Each of the side walls 43 may be covered with a thin, flexible liner 44 made, e.g., from a polyurethane or PET. As shown in the compressed state 40a, while the expanding side walls 43 may be bowed in, the flexible liners 44 may be bowed out. In some implementations, the plenum space between the bowed-in expanding side walls 43 and the bowed-out flexible liners 44 can be filled with a curable, fluid material such that, as the side walls 43 transition from the compressed state 40a to the expanded state 40b, the curable, fluid material can be forced from the plenum space into the open channel 42.

The anchor side walls 45 may be structured and arranged to include detent portions that, once the oral dental shield 40 is in an expanded state 40b, abut each of the adjacent teeth. In some variations, the anchor face 48, which contacts an adjacent tooth, is structured and arranged to be conforming so that the anchor face 48 conforms to the surface of the abutting tooth. In some implementations, the surface of the anchor face 48 that contacts the adjacent tooth may be coated with a pressure sensitive adhesive (PSA). The adhesive on the surface of the anchor face 48 may be covered with a thin, flexible removable release liner made, e.g., from a polyurethane or PET, that, during use, is removed just prior to inserting the oral dental shield 40 in a patient's mouth. Alternatively, to avoid having to use a removable liner on the anchor face 48, an adhesive may be applied to, e.g., sprayed onto or painted onto, the anchor face 48 immediately prior to insertion.

As an alternative to PSA, the surface of the conforming anchor face 48 may be saturated or slightly saturated with an UV adhesive that also may be covered with a removable liner that, during use, is removed prior to inserting the shield dental shield 40 in a patient's mouth. Once the UV adhesive is in contact with the adjacent teeth, the UV adhesive may be cured, e.g., by irradiating the UV adhesive using a UV light source.

The pair of skirts 46, which can be molded of the same material as the shield body 41, can be fabricated so that they are more rigid in one direction than another. For example, alternating ribs 47 and microfluidic channels 49 may be provided in the skirt 46 in a preferred direction, which, once the oral dental shield 40 has been inserted and positioned over the extraction area, between the adjacent teeth and the adhesive has cured, creates a shield 40 that is more flexible in the direction of the channels 49 and more rigid in a direction that is orthogonal or substantially orthogonal to the longitudinal direction of the channels 49. The microfluidic channels 49 may be open or closed. Optionally, closed channels 49 may, alternatively, be filled with a material that when it sets or is cured, hardens to provide a more rigid skirt 46 over the extraction area. The microfluidic channels 49 may be in fluidic communication with the open channel 42.

The expanding side walls 43 and the anchor side walls 45 define the open adhesive channel 42 that is formed in the shield body 41. The bottom of the molded body 41 and the bottom of the open channel 42 may be covered with a thin, flexible liner made, e.g., from a polyurethane or PET material, to prevent a fluid, e.g., a liquid or gel material, from seeping out of the bottom of the open channel 42. The open channel 42 can be filled with a predetermined volume of a fluid, gel or liquid material, e.g., an UV gel or an UV liquid material, and can be covered by a thin translucent membrane that may be removable. Once the shield 40 has been inserted into the patient's mouth and allowed to expand, the anchor faces 48 abut and conform to the adjacent teeth. Once the anchor faces 48 are abutting the adjacent teeth, the oral surgeon, dentist, or periodontist can irradiate the UV-curable material in the open channel 42, e.g., using a UV or visible light source. Irradiation cures the UV-curable material gel, thereby, locking in the shape and width of the oral dental shield 40.

Preferably, after transitioning from the compressed 40a to the expanded state 40b and curing, the liquid/gel does not swell. To address a potential for swelling, the curable material can be an acrylic urethane blend. Moreover, the blend can be fabricated in any durometer in a range bounded by being as hard as a piece of acrylic and as soft and flexible as a soft silicone. Advantageously, if one desires the oral dental shield 40 to be more rigid in one area and softer in another, separate channels 42 filled with different durometer materials may be provided.

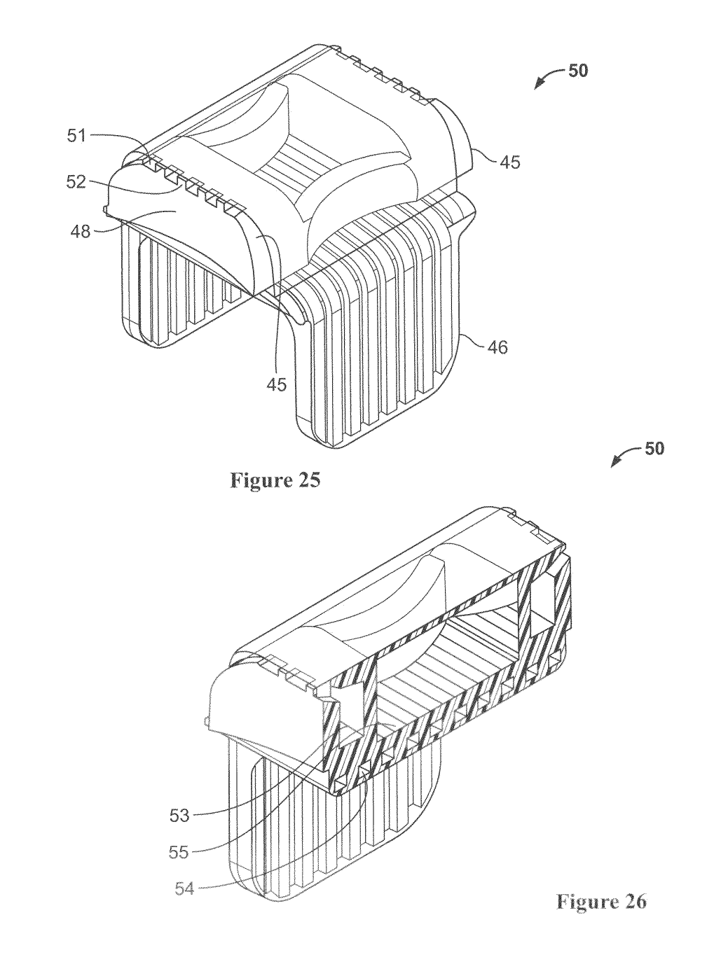

Referring to FIGS. 25 and 26, another illustrative embodiment of an expanding oral shield device 50 is shown. The expanding oral shield device 50 is similar to that described immediately above, with the addition of an adhesive reservoir 53, a plurality of openings 51, and a plurality of adhesive directors 52 integrated into the anchor side walls 45 at each end of the shield device 50. The adhesive reservoir 53 may be filled with a liquid adhesive or gel adhesive, e.g., a liquid or gel UV-cured adhesive. Once the oral shield device 50 has been inserted into the patient's mouth, the anchor side walls 45 can be manipulated to expel the liquid or gel adhesive from the reservoir 53. The plurality of adhesive directors 52 defines the plurality of openings 51 through which the adhesive gel or adhesive liquid flows out from the reservoir 53 and onto the adjacent teeth. Advantageously, the directors 52 ensure that a controlled bead of adhesive is applied to the surface of each adjacent tooth. Once sufficient adhesive has been applied to each adjacent tooth, the surgeon may irradiate the adhesive, e.g., using an UV light source, to cure the adhesive, locking the oral shield device 50 to the adjacent teeth.

Once again, although the oral shield device embodiment has been described using a UV-cured adhesive, this has been done for illustrative purposes only. There are a myriad of adhesives, especially fast setting, non-curing, temporary dental cements and resins, that may also be adapted for use with the oral shield devices described herein. For example, temporary dental cements and resins, such as those conventionally used in connection with temporary crowns, to maintain oral tissues and protect the restorative site while the permanent crown is manufactured. These cements and resins are easily removed from around the margins at the time of application; provide a good marginal seal to help minimize sensitivity; provide good retention while being easily removed; are compatible with provisional resin restoration, resin core materials, bonding agents, and permanent cements; and exhibit low solubility in oral fluids. A non-exhaustive list of commercially available temporary cements and resins that have a fast setting time, e.g., five to ten minutes; provide good retention for up to three weeks after placement; are easily removed after three weeks without damaging the adjacent teeth or leaving a residual adhesive behind; and are able to adhere to sound tooth enamel, as well as crowns made of gold, porcelain, and/or ceramics; include: zinc oxide eugenol (ZOE), zinc oxide non-eugenol (ZONE), resin temporary cement, calcium hydroxide-based cement, glass ionomer temporization cement (GIC), and polycarboxylate cement.

Having described a second embodiment of an oral shield device, a method of providing a temporary, flow-through oral shield to protect an oral surgical area during a healing process using that oral shield device will now be described. In a first step, the method includes positioning the oral dental shield in a compressed state, e.g., manually or using an applicator, over the oral surgical area such that the distal end of the oral shield is proximate a first tooth adjacent to the oral surgical area and the proximal end of the oral dental shield is proximate a second tooth adjacent to the oral surgical area. Once the oral dental shield has been positioned, the oral dental shield is allowed to expand to an expanded state to provide an interference fit with the first tooth and the second tooth. Once the expanded oral dental shield is abutting the two adjacent teeth, the adhesive, e.g., a UV-cured adhesive liquid or gel, in the channel can be cured, e.g., by radiating the adhesive using a UV light source, to adhere the oral shield to the first tooth and the second tooth. Optionally, each of the distal end and the proximal end of the oral dental shield may include a conforming attachment surface on which an adhesive is applied. In such an instance, the method further includes adhering the conforming attachment surfaces to the first tooth and the second tooth. In some variations, each of the distal end and the proximal end of the oral dental shield may include a reservoir and a plurality of openings that provide fluidic communication with the reservoir. The reservoir contains an adhesive that can be dispensed through the openings onto the first tooth and the second tooth, e.g., by manually pushing on the reservoir. Once the adhesive has been applied to the adjacent teeth, the adhesive can be cured to adhere the oral dental shield to the first tooth and the second tooth.

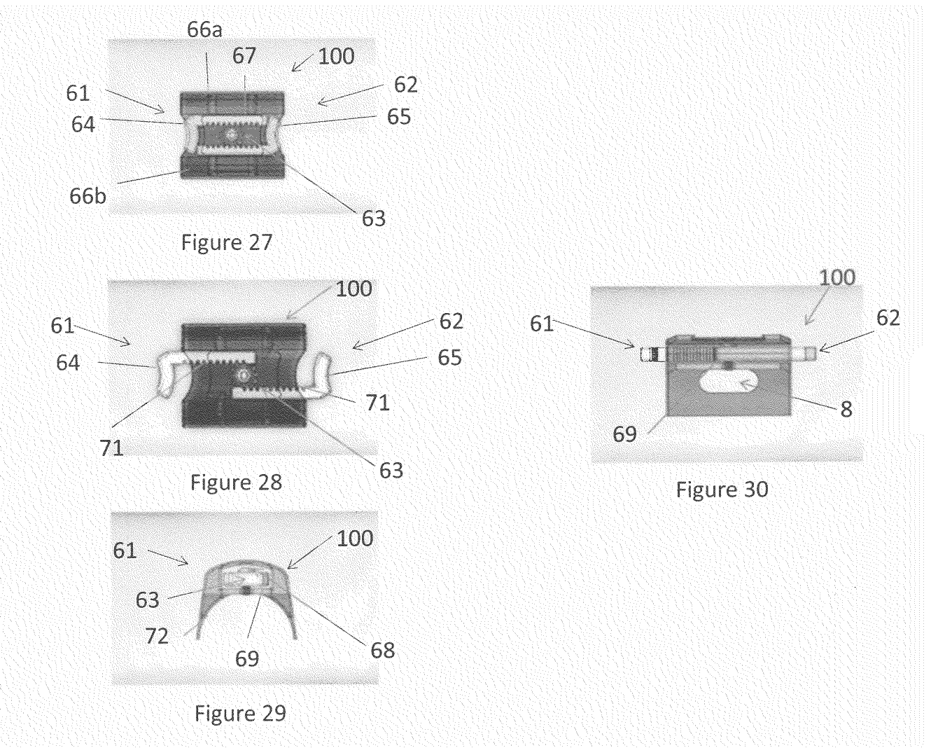

FIGS. 27-30 show an illustrative embodiment of yet another flow-through oral dental shield 100. In some embodiments, the selectively-adjustable flow-through oral dental shield 100 includes a molded body portion 60 and a pair of adjustable, extendable arms 61, 62. In some implementations, the molded body portion 60 includes a pair of opposing sidewalls 66a, 66b and a connecting base portion 69 that is formed or operatively coupled to and between the opposing sidewalls 66a, 66b. Each of the pair of opposing sidewalls 66a, 66b may include a skirt 72 that is dimensioned to extend down the gingiva 18, past the extraction site 15 to provide protection to the extraction site 15, as previously described. In some variations, the skirts 72 begin approximately where the bottom of the base portion 69 is attached to the opposing sidewalls 66a, 66b. A rinse aperture 8 may be provided through the molded body portion 60, e.g., below the base portion 69, to remove serosanguinous drainage and to provide a rinse path.

In some variations, the extendable arms 61, 62 may be L-shaped. For example, each adjustable extendable arm 61, 62 may include a long-leg portion 67 and a short-leg portion 64. In some implementations, the short-leg portion 64 may be structured and arranged as a conforming, e.g., concave, arched, curved, and the like, attachment surface 64 on which an adhesive may be applied to adhere the conforming attachment surface 64 to a tooth 17A, 17B adjacent the extraction site 15, e.g., using of an ultraviolet-cured adhesive or a non-curable fast setting temporary dental cement. The long-leg portion 67 may be structured and arranged, substantially perpendicular to the short-leg portion 64, as an elongate portion 67 having a plurality of teeth 71.

A rotatable gear 63 having a plurality of teeth 65 may be disposed on the base portion 69. In some variations, the rotatable gear 63 includes a center aperture, thorough which a pin or axle 68 may be disposed. Advantageously, the rotatable gear 63 may rotate clockwise and counterclockwise about the axle 68, respectively, to retract and to extend the arms 61, 62. For example, FIG. 27 shows a closed oral shield device 60 with the arms 61, 62 retracted. After the device 100 is properly inserted in the patient's mouth at the extraction site 15, an adjustment tool, e.g., an allen wrench, screwdriver, or the like, may be coupled to the axle 68 and turned counterclockwise, causing the teeth 65 in the gear 63 and the teeth 71 in the elongate portion 67 to mesh and to displace the extendable arms 61, 62 outwards, towards the teeth 17A, 17B adjacent to the extraction site 15.

The extendable arms 61, 62 may be extended until the conforming attachment surfaces 64 abut the adjacent teeth 17A, 17B (FIG. 28) and provide an interference fit that may be further strengthened using the adhesive formed on or applied to the conforming attachment surface 64.

For removal of the shield device 100, an adjustment tool, e.g., an allen wrench, screwdriver, or the like, may be coupled to the axle 68 and turned clockwise, causing the teeth 65 in the gear 63 and the teeth 71 in the elongate portion 67 to mesh and to retract the extendable arms 61, 62 inwards, towards the gear 63. While a rack and pinion mechanism is depicted, other extensions and retraction mechanisms may be employed, as desired.

Various embodiments and features of the present invention have been described in detail with particularity. The utilities thereof can be appreciated by those skilled in the art. It should be emphasized that the above-described embodiments of the present invention merely describe certain examples implementing the invention, including the best mode, in order to set forth a clear understanding of the principles of the invention. Numerous changes, variations, and modifications can be made to the embodiments described herein and the underlying concepts, without departing from the spirit and scope of the principles of the invention. All such variations and modifications are intended to be included within the scope of the present invention, as set forth herein. The scope of the present invention is to be defined by the claims, rather than limited by the forgoing description of various preferred and alternative embodiments. Accordingly, what is desired to be secured by Letters Patent is the invention as defined and differentiated in the claims, and all equivalents.

What is claimed is:

1. A temporary, flow-through oral shield to protect an oral surgical area during a healing process, the shield comprising:
a molded body forming a first channel extending from a distal end of the molded body to a proximal end of the molded body; and
an aperture formed in the molded body in fluid communication with the first channel.

2. The shield of claim 1, wherein the molded body comprises at least one of a translucent low durometer elastomer and a translucent silicone-based rubber.

3. The shield of claim 1, wherein the molded body forms a detent at the distal end and a detent at the proximal end to abut adjacent teeth.

4. The shield of claim 3, wherein each detent comprises a conforming surface having an adhesive layer to adhere the conforming surfaces of the shield to the adjacent teeth.

5. The shield of claim 4, wherein the adhesive layer comprises an ultraviolet-cured adhesive.

6. The shield of claim 1, wherein the molded body comprises a concave undercut portion and a crown portion.

7. The shield of claim 6, wherein the aperture is disposed in the crown portion of the molded body.

8. The shield of claim 1 further comprising a removable spacer.

9. The shield of claim 8, wherein when the spacer is removably disposed in the molded body and is adapted to provide a buffer zone proximate the oral surgical area when removed, to allow a fluid to flow across the oral surgical area.

10. The shield of claim 8, wherein the removable spacer includes a gripper to facilitate removing the spacer.

11. The shield of claim 1 further comprising a second channel formed through the molded body to allow a liquid to flow across the oral surgical area.

12. The shield of claim 1, wherein the distal end includes a first opening and the proximal end includes a second opening.

13. The shield of claim 12 further comprising a seal disposed about each of the first opening and the second opening.

14. The shield of claim 1 further comprising a flow director disposed within the first channel proximate an intersection of the first channel with the aperture.

15. The shield of claim 1, wherein the molded body comprises a compliant resilient material so as to extend from a compressed state to an expanded state.

16. The shield of claim 1, wherein the first channel contains at least one of an adhesive liquid and an adhesive gel.

17. The shield of claim 1, wherein the molded body comprises a first reservoir in fluid communication with a first opening at the distal end and a second reservoir in fluid communication with a second opening at the proximal end.

18. The shield of claim 17, wherein the first and second reservoirs contain at least one of an adhesive liquid and an adhesive gel.

19. The shield of claim 17, wherein each of the first and second openings includes at least one flow director.

20. The shield of claim 1 wherein each of the distal end and proximal end of the molded body includes a conforming attachment surface comprising an adhesive.

21. An oral shield system for providing a temporary, flow-through oral shield to protect an oral surgical area during a healing process, the system comprising:
a shield comprising:
a molded body forming a first channel extending from a first opening at a distal end of the molded body to a second opening at a proximal end of the molded body; and
an aperture formed in the molded body in fluid communication with the first channel; and
a disposable packet containing an adhesive.

22. The system of claim 21, wherein the shield further comprises a removable spacer.

23. The system of claim 22, wherein the spacer is removably disposed in the molded body and is adapted to provide a buffer zone proximate the oral surgical area when removed, to allow a liquid to flow across the oral surgical area.

24. The system of claim 21, wherein the adhesive comprises an ultraviolet-cured adhesive.

25. The system of claim 24 further comprising an ultraviolet light source to cure the adhesive.

26. The system of claim 21, wherein the adhesive comprises non-curable fast setting temporary dental cement.

27. The system of claim 21, wherein the disposable packet includes a nozzle configured to mate with the aperture, to introduce adhesive into the aperture.

28. A method of providing a temporary, flow-through oral shield to protect an oral surgical area during a healing process, the oral shield including a molded body forming a channel extending from a first opening at a distal end of the molded body to a second opening at a proximal end of the molded body, and an aperture formed in the molded body in fluid communication with the channel, the method comprising:
positioning the oral shield over the oral surgical area such that the first opening is adjacent to a first tooth adjacent to the oral surgical area and the second opening is adjacent to a second tooth adjacent to the oral surgical area;
introducing an adhesive into the aperture until the adhesive contacts the first tooth and the second tooth after flowing through the channel; and
at least one of curing and setting the adhesive, to adhere the oral shield to the first tooth and the second tooth.

29. The method of claim 28, wherein the oral shield further includes a removable spacer, the method further comprising:
when positioning the oral shield over the oral surgical area, resting the spacer on the oral surgical area to space the molded body from the oral surgical area; and
removing the spacer from the molded body of the oral shield to create a buffer zone.

30. The method of claim 28, wherein the adhesive comprises an ultraviolet-curable adhesive and curing the adhesive comprises radiating the ultraviolet-curable adhesive with ultraviolet light.

31. A method of providing a temporary, flow-through oral shield to protect an oral surgical area during a healing process, the oral shield comprising a molded body forming a channel extending from a distal end of the molded body to a proximal end of the molded body and containing an adhesive, and an aperture formed in the molded body in fluid communication with the channel, the method comprising:
positioning the oral shield in a compressed state over the oral surgical area such that the distal end is proximate a first tooth adjacent to the oral surgical area and the proximal end is proximate a second tooth adjacent to the oral surgical area;
expanding the oral shield to an expanded state to provide an interference fit with the first tooth and the second tooth; and
at least one of curing and setting the adhesive in the channel to adhere the oral shield to the first tooth and the second tooth.

32. The method of claim 31, wherein each of the distal end and the proximal end comprises a conforming attachment surface on which an adhesive is applied, the method further comprising:
adhering the conforming attachment surfaces to the first tooth and the second tooth.

33. The method of claim 31, wherein each of the distal end and the proximal end comprises a reservoir containing an adhesive and forms an opening, the method further comprising:
dispensing the adhesive from the reservoirs through the openings onto the first tooth and the second tooth; and
curing the adhesive to adhere the oral shield to the first tooth and the second tooth.

34. The method of claim 33, wherein the adhesive comprises an ultraviolet-curable adhesive and curing the adhesive includes radiating the ultraviolet-curable adhesive using an ultraviolet light.
